(19) United States
(12) Patent Application Publication
(10) Pub. No.: US 2024/0332537 A1
(43) Pub. Date: Oct. 3, 2024

(54) SOLID-STATE SECONDARY BATTERY

(71) Applicant: HONDA MOTOR CO., LTD., Tokyo (JP)

(72) Inventors: Takashi NAKAGAWA, Saitama (JP); Yohei NOJI, Saitama (JP); Hiroki ICHIHARA, Saitama (JP); Kyohei IZUMI, Saitama (JP)

(21) Appl. No.: 18/621,131

(22) Filed: Mar. 29, 2024

(30) Foreign Application Priority Data
Mar. 31, 2023 (JP) 2023-059654

(51) Int. Cl. H01M 4/62; H01M 10/0562; H01M 50/105; H01M 50/471

(52) U.S. Cl. CPC H01M 4/628; H01M 10/0562; H01M 50/105; H01M 50/471; H01M 2300/0068

(57) ABSTRACT

A solid-state secondary battery according to the present invention includes an electrode laminate, and an exterior body accommodating the electrode laminate. The electrode laminate has a positive electrode layer, a negative electrode layer, and a solid electrolyte layer placed between the positive electrode layer and the negative electrode layer. The positive electrode layer includes a positive electrode current collector and a positive electrode active material layer. The solid electrolyte layer has a positive electrode-facing region that faces the positive electrode active material layer, and a positive electrode-non-facing region that does not face the positive electrode layer. The positive electrode-non-facing region has a porosity of lower than 5%.

This application is based on and claims the benefit of priority from Japanese Patent Application No. 2023-059654, filed on 31 Mar. 2023, the content of which is incorporated herein by reference.

### BACKGROUND OF THE INVENTION

### Field of the Invention

The present invention relates to a solid-state secondary battery.

### Related Art

In recent years, researchers and developments on secondary batteries that contribute to energy efficiency have been conducted to allow more people to access an affordable, reliable, sustainable, and advanced energy. Among secondary batteries, particularly solid secondary batteries made of solid electrolytes have attracted attention in terms of safety improved by incombustible solid electrolytes and of higher energy density.

In solid secondary batteries, metal ions such as lithium ions used as charge transfer media may precipitate between a solid electrolyte layer and a negative electrode layer due to repeated charge and discharge. The performance of the solid secondary battery may be lowered due to deterioration of interface bondability caused by the precipitation of the metal, or the like. In response to this issue, there is a known technology to make it difficult to generate dead lithium by providing a layer that allows precipitation of lithium metal and covers the negative electrode current collector and precipitating lithium metal uniformly on the surface of the covering layer (e.g. see Patent Document 1).

Patent Document 1: Japanese Unexamined Patent Application, Publication No. 2018-129159

### SUMMARY OF THE INVENTION

Solid secondary batteries have a problem of improving the cyclability. In particular, if a size and a structural design, and a process condition of a solid-state secondary battery is inappropriate, metal ions as charge transfer media are likely to precipitate on an end portion of a solid electrolyte layer in some cases. When an intermediate layer is provided between the solid electrolyte layer and the negative electrode current collector, metal ions are likely to precipitate also on an end portion of an intermediate layer in some cases. If metal ions precipitate on the end portion of the solid electrolyte layer or the intermediate layer, the precipitated metal may accumulate and therefore cause a short circuit between the positive electrode layer and the negative electrode layer, or side reactions may locally occur, resulting in increased resistance and lowered cyclability.

The present invention has been made in view of the above-mentioned circumstances, and an object of the present invention is to provide a solid-state secondary battery that suppresses precipitation of metal ions on end portions of a solid electrolyte layer and an intermediate layer even after repeated charge and discharge, and has excellent cyclability. Consequently, the battery contributes to a higher energy efficiency.

The inventors have found that the above-described problems can be solved by providing a positive electrode-non-facing region that does not face a positive electrode layer and using the positive electrode-non-facing region as a dense solid electrolyte layer having a low porosity. This finding has completed the present invention. Thus, the present invention provides the following aspects.

(1) A solid-state secondary battery including an electrode laminate, and an exterior body housing the electrode laminate, the electrode laminate having a positive electrode layer, a negative electrode layer, and a solid electrolyte layer placed between the positive electrode layer and the negative electrode layer, the positive electrode layer including a positive electrode current collector and a positive electrode active material layer, the solid electrolyte layer having a positive electrode-facing region that faces the positive electrode active material layer, and a positive electrode-non-facing region that does not face the positive electrode layer, and the positive electrode-non-facing region having a porosity of lower than 5%.

In the solid-state secondary battery according to (1), since the positive electrode-non-facing region has a porosity as low as 5% or lower and is dense, metal ions released from the positive electrode layer and negative electrode layer are less likely to move within the positive electrode-non-facing region during charging and discharging. Thus, metal ions are less likely to precipitate on the end portion of the solid electrolyte layer. Thus, the solid-state secondary battery according to (1) has an excellent cyclability.

(2) The solid-state secondary battery according to (1), in which an equation: −3%≤(D1−D2)/D1×100≤+3% is satisfied under a condition that an apparent density of the positive electrode-facing region is defined as D1 and an apparent density of the positive electrode-non-facing region is defined as D2.

In the solid-state secondary battery according to (2), a ratio [(D1−D2)/D1×100] of a difference between the apparent densities of the positive electrode-facing region and positive electrode-non-facing region (D1−D2) to the apparent density D1 of the positive electrode-facing region is low, and the difference in the apparent density between the positive electrode-facing region and the positive electrode-non-facing region is small. Thus, metal ions released from the positive electrode layer and negative electrode layer and fed to the positive electrode-facing region are less likely to move toward the positive electrode-non-facing region side, and the metal ions are less likely to precipitate on the end portion of the solid electrolyte layer.

(3) The solid-state secondary battery according to (1) or (2), in which adhesion strength within layers of the positive electrode-non-facing region of the solid-electrolyte layer is greater than 0.3 kN/m.

In the solid-state secondary battery according to (3), since the adhesion strength within layers of the positive electrode-non-facing region of the solid-electrolyte layer is greater than 0.3 kN/m and the shape stability of the positive electrode-non-facing region is high, the metal ions are less likely to deposit at the end portion of the solid-electrolyte layer over a long period of time.

(4) The solid-state secondary battery according to any one of (1) to (3), in which an equation: (E1−E2)/E1×100≤15% is satisfied under a condition that the composite modulus elasticity of the positive electrode-facing region of the solid-electrolyte layer is defined as E1 and the composite modulus of elasticity of the positive electrode-non-facing region is defined as E2.

(4) In the solid-state secondary battery, since the ratio [(E1−E2)/E1×100] of the difference (E1−E2) between the composite modulus of elasticity of the positive electrode-facing region and the composite modulus of elasticity of the positive electrode-non-facing region to the composite modulus of elasticity of the positive electrode facing region is as low as 15% or less and the difference in the composite elastic moduli between the positive electrode-facing region and the positive electrode-non-facing region is small. This reduces variations in the thicknesses of the positive electrode-facing region and the positive electrode-non-facing region when a restraining force is applied to the solid-state secondary battery. Thereby, even when a restraining force is applied to the solid-state secondary battery, the interface and the structure of each member in the solid secondary battery can be maintained and local reaction and current concentration can be suppressed.

(5) The solid-state secondary battery according to any one of (1) to (4), in which the solid electrolyte layer contains a sulfide solid electrolyte material.

In the solid-state secondary battery according to (5), since the solid electrolyte layer contains a sulfide solid electrolyte material, a dense positive electrode-non-facing region having a low porosity can be easily formed.

(6) The solid-state secondary battery according to any one of (1) to (5), in which an intermediate layer is provided between the negative electrode layer and the solid electrolyte layer, and the intermediate layer has a porosity higher than that of the solid electrolyte layer.

In the solid-state secondary battery according to (6), even when the intermediate layer is provided, the metal ions are less likely to precipitate on the end portion of the intermediate layer because the solid electrolyte layer has the positive electrode-non-facing region. Since the intermediate layer has a porosity higher than that of the solid electrolyte layer, uneven metal precipitation on the negative electrode layer interface can be suppressed, and the cyclability can be further improved.

(7) The solid-state secondary battery according to (6), in which the intermediate layer has a thickness of 5 μm or less in a lamination direction of the electrode laminate.

In the solid-state secondary battery according to (7), since the intermediate layer has a thickness of 5 μm or less, the metal as a charge transfer medium for charging can be precipitated at a position between the intermediate layer and the negative electrode layer. Thereby, a frequency of direct contact between the electrolyte layer and the precipitated metal can be considerably decreased and local degradation and current concentration in the electrolyte layer can be suppressed, improving cyclability and preservability. Furthermore, a relatively elastic intermediate layer can be placed between the hard electrolyte layer and the precipitated metal, thereby it becomes easy to follow the expansion and contraction caused by precipitation and dissolution of the metal, so that a uniform reaction in an in-plane direction and a thickness direction can be performed, resulting in effects of reducing the resistance and improving the cyclability.

(8) The solid-state secondary battery according to (6) or (7), in which the intermediate layer contains metal nanoparticles and amorphous carbon.

In the solid-state secondary battery according to (8), electronic conductivity of the intermediate layer can be ensured, and voids through which the charge transfer medium can move within the intermediate layer can be retained even when the intermediate layer is formed under high pressure, resulting in an effect of reducing the resistance.

(9) The solid-state secondary battery according to any one of (1) to (8), in which an outer periphery of the positive electrode active material layer is surrounded by an insulating frame.

In the solid-state secondary battery according to (9), since the outer periphery of the positive electrode active material layer is surrounded by an insulating frame and the positive electrode-non-facing region can be supported by the insulating frame, the strength of the positive electrode-non-facing region can be improved. Furthermore, even if the metal accumulates on the end portion of the solid electrolyte layer and the intermediate layer, the metal is less likely to extend around the positive electrode active material layer. This makes it more difficult for the positive electrode layer and negative electrode layer to cause a short circuit, and the cyclability is further improved.

According to the present invention, it is difficult for metal ions to precipitate on the end portions of the solid electrolyte layer and the intermediate layer even after repeated charge and discharge, and thereby solid-state secondary batteries having excellent cyclability can be provided.

### BRIEF DESCRIPTION OF THE DRAWINGS

FIG. 1 is a top view of an electrode laminate of a solid-state secondary battery according to an embodiment of the present invention;

FIG. 2 is a sectional view taken along line II-II in FIG. 1;

FIG. 3 is a sectional view of the electrode laminate illustrated in FIG. 2 during charging; and

FIG. 4 is a sectional view of the solid-state secondary battery according to an embodiment of the invention.

### DETAILED DESCRIPTION OF THE INVENTION

The embodiment of the present invention will be explained below with reference to the figures. Note that the embodiment described below is intended to merely illustrate the present invention, and the present invention is not limited to the following description.

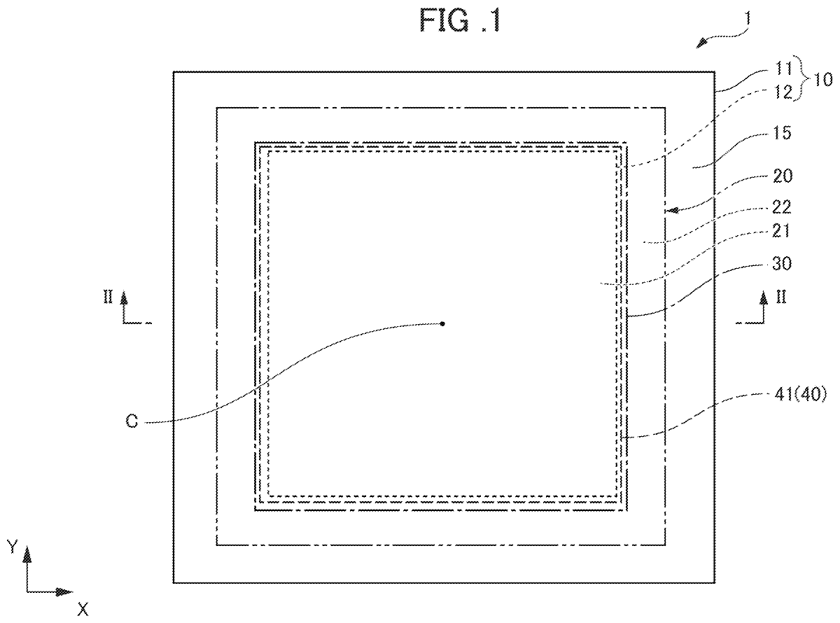

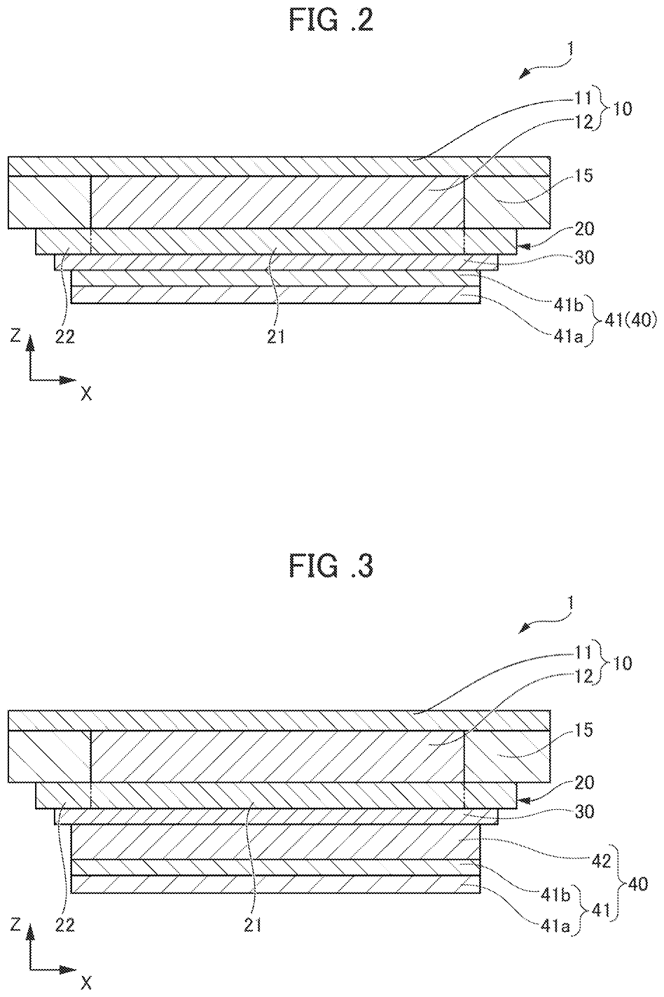

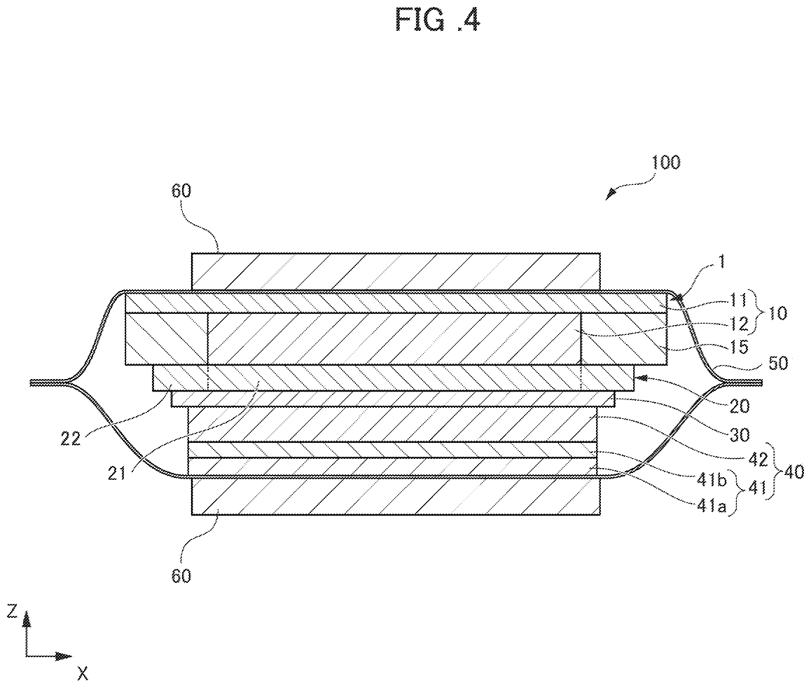

FIG. 1 is a top view of an electrode laminate of a solid-state secondary battery according to an embodiment of the present invention. FIG. 2 is a sectional view taken along line II-II in FIG. 1, and FIG. 3 is a sectional view of the electrode laminate illustrated in FIG. 2 during charging. FIG. 4 is a sectional view of the solid-state secondary battery having the electrode laminate illustrated in FIG. 1 to FIG. 3. In FIG. 1 to FIG. 4, the X-direction indicated by arrow X is one direction parallel to the top surface of the electrode laminate viewed from above. The Y-direction indicated by arrow Y is parallel to the top surface of the electrode laminate viewed from above and orthogonal to the X-direction. The Z-direction indicated by arrow Z is a lamination direction of the electrode laminate.

A solid-state secondary battery 100 according to the present embodiment includes an electrode laminate 1, as illustrated in FIG. 4. The electrode laminate 1 is a laminate including a positive electrode layer 10, a solid electrolyte layer 20, an intermediate layer 30, and a negative electrode layer 40 laminated in this order, as illustrated in FIG. 1 to FIG. 3. The positive electrode layer 10 includes a positive electrode current collector 11 and a positive electrode active material layer 12. An outer periphery of the positive electrode active material layer 12 is surrounded by an insulating frame 15. The negative electrode layer 40 includes a negative electrode current collector 41. The electrode laminate 1 illustrated in FIG. 1 and FIG. 2 is in a discharged state, and the electrode laminate 1 illustrated in FIG. 3 is in a charged state. The negative electrode layer 40 in the charged state has a metal precipitate layer 42 produced by precipitation of metal ions as charge negative electrode active materials on the surface of the negative electrode current collector 41 on the intermediate layer 30 side. The metal precipitate layer 42 serves as the negative electrode active material layer and releases metal ions during discharging. The thickness of the negative electrode layer 40 in the electrode laminate 1 is changed along with charge and discharge.

The electrode laminate 1 is rectangular with the X-directional length larger than the Y-directional length viewed from above, as illustrated in FIG. 1. The electrode laminate 1 may be square or circular viewed from above.

The positive electrode layer 10, the solid electrolyte layer 20, the intermediate layer 30, and the negative electrode layer 40 are each laminated such that their centers C coincide with each other. A relationship: Sp<Sn≤Sm≤Ss may be satisfied under a condition that an area of the positive electrode active material layer 12 viewed from above is defined as Sp, an area of the solid electrolyte layer 20 viewed from above is defined as Ss, an area of the intermediate layer 30 viewed from above is defined as Sm, and an area of the negative electrode layer 40 viewed from above is defined as Sn. In the present embodiment, the relationship between the areas of each layer is expressed by Sp<Sn=Sm<Ss. The relationship between the areas of each layer may be expressed by Sp<Sn<Sm=Ss, Sp<Sn=Sm=Ss, or Sp<Sn<Sm<Ss. When the areas of each layer satisfy the above relationship, the electrode laminate 1 has a configuration in which the end portion of the positive electrode active material layer 12 is the innermost and the end portions of the other layers (solid electrolyte layer 20, intermediate layer 30, and negative electrode layer 40) are outside of the end portion of the positive electrode active material layer 12, as viewed from above. In the electrode laminate 1 having this configuration, the end portion of the positive electrode active material layer 12 and the end portions of the other layers are located away from each other, so that metal ions (charge transfer media) released from the positive electrode active material layer 12 during charging are less likely to precipitate on the end portions of the other layers. A ratio Sn/Sp of the area Sn of the negative electrode layer 40 to the area Sp of the positive electrode active material layer 12 may be e.g. within a range of 1.05 to 1.45. A ratio Sm/Sp of the area Sm of the intermediate layer 30 to the area Sp of the positive electrode active material layer 12 may be e.g. within a range of 1.10 to 1.45. A ratio Ss/Sp of the area Ss of the solid electrolyte layer 20 to the area Sp of the positive electrode active material layer 12 may be e.g. within a range of 1.25 to 2.00.

The material and the shape of the positive electrode current collector 11 are not particularly limited as long as they have a function of collecting electricity for the positive electrode layer 10. Preferably, the area of the positive electrode current collector 11 is the same as or larger than that of the positive electrode active material layer 12, viewed from above. Examples of the material for the positive electrode current collector 11 include aluminum, aluminum alloy, stainless steel, nickel, iron, and titanium. Above all, aluminum alloy, and stainless steel are preferable. Examples of the shape of the positive electrode current collector 11 include a foil shape and a plate shape.

The positive electrode active material layer 12 contains at least one positive electrode active material. The positive electrode active material is not particularly limited, and those used for positive electrode layers of general solid secondary batteries can be used. Examples of the positive electrode active material include a lithium-containing layered active material, a spinel type active material, and an olivine type active material. Specific examples of the positive electrode active material include lithium cobaltate (LiCoO₂), lithium nickelate (LiNiO₂), LiNiₚMn_{q}CoᵣO₂ (p+q+r=1), LiNiₚAl_{q}COᵣO₂ (p+q+r=1), lithium manganate (LiMn₂O₄), heteroelement-substituted Li—Mn spinel represented by Li₁₊ₓMn_{2-x-y}MO₄ (x+y=2, M is at least one selected from Al, Mg, Co, Fe, Ni, and Zn), lithium titanate (oxide containing Li and Ti), and metallic lithium phosphate (LiMPO₄, M is at least one selected from Fe, Mn, Co, and Ni).

The positive electrode active material layer 12 may optionally contain a solid electrolyte from the viewpoint of improving a charge transfer medium conductivity. Also, the positive electrode active material layer 12 may optionally contain a conductive assistant to improve the electric conductivity. Furthermore, the positive electrode active material layer 12 may optionally contain a binder from the viewpoint of expressing flexibility, or the like. The solid electrolyte, the conductive assistant, and the binder are not particularly limited, and those used for positive electrode layers of general solid secondary batteries can be used.

The solid electrolyte layer 20 is laminated between the positive electrode layer 10 and the negative electrode layer 40. The solid electrolyte layer 20 has a positive electrode-facing region 21 that faces the positive electrode layer 10 and a positive electrode-non-facing region 22 that does not face the positive electrode layer 10. The positive electrode-non-facing region 22 extends beyond the edge portion of the positive electrode active material layer 12, viewed from above. For example, the end portion of the positive electrode-not-facing region 22 may be 1.0 mm or longer away from or 0.5 to 5.0 mm away from the end portion of the positive electrode-facing region 21.

The solid electrolyte layer 20 contains at least one solid electrolyte material. The positive electrode-facing region 21 and the positive electrode-non-facing region 22 of the solid electrolyte layer 20 may contain the same solid electrolyte material. The solid electrolyte layer 20 can conduct the charge transfer medium between the positive electrode layer 10 and the negative electrode layer 40 via the solid electrolyte material contained in the solid electrolyte layer 20.

The solid electrolyte material is not particularly limited as long as it has a charge transfer medium conductivity, and examples thereof include a sulfide solid electrolyte material, an oxide solid electrolyte material, a nitride solid electrolyte material, and a halide solid electrolyte material.

Examples of the sulfide solid electrolyte material include Li₂S—P₂S₅ and Li₂S—P₂S₅—LiI. The above description “Li₂S—P₂S₅” means a sulfide solid electrolyte material made of a raw material composition containing Li₂S and P₂S₅, and the same applies to the other similar descriptions below. The sulfide solid electrolyte material may have an argyrodite type crystal structure.

Examples of the oxide solid electrolyte material include a NASICON type oxide, a garnet type oxide, and a perovskite type oxide. Examples of the NASICON type oxide include oxides containing Li, Al, Ti, P, and O (e.g. Li_{1.5}Al_{0.5}Ti_{1.5} (PO₄)₃). Examples of the garnet type oxide include oxides containing Li, La, Zr, and O (e.g. Li₂La₃Zr₂O₁₂). Examples of the perovskite-type oxide include oxides containing Li, La, Ti, and O (e.g. LiLaTiO₃).

The solid electrolyte material constituting the solid electrolyte layer 20 has a particle diameter of e.g. 0.5 to 10 μm in median diameter (D50), which is preferably larger than the particles constituting the intermediate layer 30 described below.

The positive electrode-facing region 21 and the positive electrode-non-facing region 22 may have voids. The positive electrode-non-facing region 22 has a porosity of lower than 5%. The porosity of the positive electrode facing region 21 is not particularly limited and may be lower than the porosity of the intermediate layer 30, e.g. lower than 10%. The porosities of the positive electrode-facing region 21 and the positive electrode-non-facing region 22 may be the same, or the porosity of the positive electrode-facing region 21 may be lower, or the porosity of the positive electrode-non-facing region 22 may be lower.

The porosities of the positive electrode-facing region 21 and the positive electrode-non-facing region 22 can be determined e.g. by the following equation (1). In equation (1), the “filling rate” means a percentage of an apparent density to a true density of the positive electrode-facing region 21 or the positive electrode-non-facing region 22.

$$Porosity ( \% ) = 100 - filling rate ( \% ) \qquad ( 1 )$$

The positive electrode-facing region 21 and the positive electrode-non-facing region 22 may satisfy an equation: −3%≤(D1−D2)/D1×100≤+3% under a condition that the apparent density of the positive electrode-facing region 21 is defined as D1 and the apparent density of the positive electrode-non-facing region 22 is defined as D2. The solution of the equation (D1−D2)/D1×100 may be −3% or higher and lower than 0%, or may be higher than 0% and 3% or lower.

Furthermore, the positive electrode-facing region 21 and the positive electrode-non-facing region 22 may satisfy an equation: (E1−E2)/E1×100≤15% under a condition that the composite elastic modulus of the positive electrode-facing region 21 is defined as E1 and the composite elastic modulus of the positive electrode-non-facing region 22 is defined as E2.

The solid electrolyte layer 20 with the positive electrode-facing region 21 and the positive electrode-non-facing region 22 having porosities and apparent densities within the above ranges is dense and not likely to adsorb moisture. The solid electrolyte layer 20 may have a moisture content of 700 ppm by mass or less, or 500 ppm by mass or less, after drying under vacuum at lower than 100 Pa and at 110° C. for 1 hour. By using the solid electrolyte layer 20 having a low moisture content, decrease in ionic conductivity of the solid electrolyte layer can be suppressed, and denaturation of the positive electrode layer 10, the intermediate layer 30, and the negative electrode layer 40 due to moisture can be suppressed, so that the cyclability of the solid-state secondary battery 100 is further improved. The moisture content of the solid electrolyte layer 20 after drying can be measured by Karl Fischer method.

The positive electrode-non-facing region 22 may have a volume resistivity (20° C.) of e.g. within a range of 1×10⁷ to 1×10⁹. When the positive electrode-non-facing region 22 contains a sulfide solid electrolyte material, the positive electrode-non-facing region 22 may have a volume resistivity (20° C.) within a range of 1×10⁷ to 1×10⁸. When the positive electrode-non-facing region 22 contains an oxide solid electrolyte material, the positive electrode-non-facing region 22 may have a volume resistivity (20° C.) within a range of 1×10⁸ to 1×10⁹.

The strength (adhesive strength in layers) when the positive electrode non-facing region 22 is peeled off in a layered manner as measured by a SAICAS method may be greater than 0.3 kN/m. The adhesion strength in layers indicates the shape stability of the positive electrode non-facing region 22. When the adhesion strength in layers is large, a crack or a chip in layered manner is less likely to occur in the positive electrode non-facing region 22, which increases the shape stability.

The intermediate layer 30 is laminated between the solid electrolyte layer 20 and the negative electrode layer 40. The intermediate layer 30 functionally suppresses uneven precipitation of the metal ions on the interface of the negative electrode layer 40 to improve the interface adhesion.

Preferably, the intermediate layer 30 has an electronic conductivity and has voids through which the metal ions (e.g. lithium ions) as the charge transfer media can pass. When the intermediate layer 30 has voids, the metal ions moving from the solid electrolyte layer 20 toward the negative electrode layer 40 pass through the intermediate layer 30 during charging of the solid-state secondary battery 100, and precipitate on the surface of the negative electrode current collector 41 of the negative electrode layer 40 on the intermediate layer 30 side to produce a metal precipitate layer 42 (layer of metallic lithium). By allowing the metal ions to pass through the intermediate layer 30, the metal precipitate layer 42 can be produced uniformly on the surface of the negative electrode current collector 41. When the intermediate layer 30 has voids, the intermediate layer 30 acquires pliability enough to follow changes in the thickness of the negative electrode layer 40 along with charge and discharge. Thus, even when the solid-state secondary battery 100 is repeatedly charged and discharged, the interface adhesion can be maintained and the durability of the solid-state secondary battery 100 can be improved.

Preferably, the intermediate layer 30 has a porosity higher than that of the solid electrolyte layer 20. Thereby, since more voids through which metal ions can pass are formed in the intermediate layer 30, the metal precipitate layer 42 can be more uniformly formed on the surface of the negative electrode current collector 41. Furthermore, since the intermediate layer 30 is made more pliable, followability for the change in the thickness of the negative electrode layer 40 is improved. The intermediate layer 30 can have a porosity of e.g. 40 to 70%. To calculate the porosity of the intermediate layer 30, the same method as for the porosity of the solid electrolyte layer 20 can be applied.

The intermediate layer 30 may have a thickness of 5 μm or less. If the thickness of the intermediate layer 30 is 5 μm or less, the metal as the charge transfer medium for charging can be precipitated at a position between the intermediate layer 30 and the negative electrode layer 40. Thereby, a frequency of direct contact between the solid electrolyte layer 20 and the precipitated metal can be considerably decreased, local degradation and current concentration in the solid electrolyte layer 20 can be suppressed, improving cyclability and preservability. Furthermore, a relatively elastic intermediate layer 30 can be placed between the hard solid electrolyte layer 20 and the precipitated metal, thereby the battery easily follows the expansion and contraction caused by precipitation and dissolution of the metal, so that a uniform reaction in an in-plane direction and a thickness direction, resulting in effects of reducing the resistance and improving the cyclability. Furthermore, to further obtain the effects of reducing the resistance and improving the cyclability, the intermediate layer may have a thickness of 3 μm or less, or 1 to 3 μm.

Preferably, the intermediate layer 30 contains amorphous carbon and metal nanoparticles. Owing to the amorphous carbon and metal nanoparticles, electronic conductivity of the intermediate layer 30 can be ensured, and voids through which the charge transfer media can move within the intermediate layer 30 can be retained even when the intermediate layer 30 is formed under high pressure, resulting in an effect of reducing the resistance. The intermediate layer 30 may further contain a binder as a binding material to maintain the structure.

For example, unlike graphite or the like, amorphous carbon is less likely to react with metals such as lithium to form an alloy, therefore formation of dendrites can be suppressed, and the cyclability of the solid-state secondary battery can be improved. The amorphous carbon may be an easily graphitizable carbon (soft carbon) or a poorly graphitizable carbon (hard carbon). The amorphous carbon only needs to be any carbon allotrope that does not exhibit a distinct crystalline condition, and may be an aggregate of black lead fine crystals. Specific examples of the amorphous carbon include carbon blacks such as acetylene black, furnace black, and Ketjen black, coke, activated carbon, carbon nanotubes (CNT), fullerene, and graphene.

Examples of the metal nanoparticles include metal nanoparticles of tin (Sn), silicon (Si), zinc (Zn), magnesium (Mg), gold (Au), platinum (Pt), palladium (Pd), silver (Ag), aluminum (Al), bismuth (Bi), and antimony (Sb). A content of the metal nanoparticles is preferably more than 0% by mass and 30% by mass or less based on the intermediate layer 30. When the intermediate layer 30 contains metal nanoparticles, the electronic conductivity of the intermediate layer 30 can be increased, and the metal precipitate layer 42 can be more uniformly produced. Furthermore, since the metal nanoparticles have a Young's modulus higher than that of the amorphous carbon, the structure of the intermediate layer 30 can be retained even when the intermediate layer 30 is pressed under high pressure when manufacturing the solid-state secondary battery 100.

The particle diameters of the amorphous carbon, metal nanoparticles, and the like are preferably smaller than that of the solid electrolyte material. This allows the intermediate layer 30 to be inserted into the gap between the solid electrolyte materials constituting the interface of the solid electrolyte layer 20, therefore the contact area between the solid electrolyte layer 20 and the intermediate layer 30 can be increased, and adhesion of the contact face can be improved. The amorphous carbon may have a particle diameter of e.g. within a range of 0.02 to 0.10 μm in median diameter (D50). The metal nanoparticles may have a particle diameter of e.g. within a range of 0.02 to 0.20 μm in median diameter (D50).

Preferably, the binder can improve the adhesion between particles constituting the intermediate layer 30 and the adhesion between the intermediate layer 30 and the solid electrolyte layer 20. The binder is not particularly limited, and any binder for general solid secondary batteries can be used. Examples of the binder include an acrylic acid-based polymer, a cellulose-based polymer, a styrene-based polymer, a vinyl acetate-based polymer, a urethane-based polymer, and a fluoroethylene-based polymer, as well as a polyvinylidene fluoride (PVDF)-based polymer.

The negative electrode current collector 41 has a current collecting substrate 41a, and a metal layer 41b laminated on the surface of the current collecting substrate 41a. The material and the shape of the current collecting substrate 41a are not particularly limited as long as they have a function of collecting electricity for the negative electrode layer 40. Examples of the material of the current collecting substrate 41a include nickel, copper, and stainless steel. Examples of the shape of the current collecting substrate 41a include a foil shape and a plate shape.

The material and the shape of the metal layer 41b are not particularly limited as long as they have a function of precipitating dense charge transfer media such as lithium ions. When the charge transfer media are lithium ions, metallic lithium or a metal that forms an alloy with lithium can be used as the material for the metal layer 41b. Examples of the metal that forms an alloy with lithium include Mg, Si, Au, Ag, In, Ge, Sn, Pb, Al, and Zn. The metal for forming the metal layer 41b may be in a powder form or in a thin film form. The negative electrode current collector 41 including this metal layer 41b makes it possible to uniformly produce the metal precipitate layer 42 on the surface of the negative electrode current collector 41. The metal layer 41b may be omitted, and, instead, lithium ions may be precipitated directly on the current collecting substrate 41a.

As illustrated in FIG. 4, the electrode laminate 1 is accommodated in an exterior body 50. A pair of restraining members 60 for applying a restraining force to the electrode laminate 1 are placed on the outer surface of the exterior body 50. The solid-state secondary battery 100 has a positive electrode tab (not illustrated) with one end connected to the positive electrode current collector 11 and the other end protruding outward, and a negative electrode tab (not illustrated) with one end connected to the negative electrode current collector 41 and the other end protruding outward.

The exterior body 50 is configured to be expandable and contractible accompanying the change of the negative electrode thickness along with charge and discharge. A laminated film can be used as the material for the exterior body 50. As the laminate film, a three-layer laminated film including an inner resin layer, a metal layer, and an outer resin layer laminated in this order from the inside can be used. The outer resin layer may be e.g. a polyamide (nylon) layer or a polyethylene terephthalate (PET) layer. The metal layer may be e.g. an aluminum layer. The inner resin layer may be e.g. a polyethylene or polypropylene layer. Also, adhesive layers may be provided between the respective layers, and may be integrated by heat or pressure.

A ratio of the thickness of the positive electrode layer 10 to the thickness of the negative electrode layer 40 (thickness of the negative electrode current collector 41) (thickness of the positive electrode layer 10/thickness of the negative electrode layer 40) during charging may be 1.9 or higher to ensure a clearance inside the exterior body 50.

The restraining members 60 apply a restraining force in a lamination direction of the electrode laminate 1. Preferably, the restraining members 60 satisfy a relationship: Sn≤Sr under a condition that an area of the restraining member 60 viewed from above is defined as Sr and an area of the negative electrode layer 40 viewed from above is defined as Sn. When the area Sr of the restraining member 60 satisfies this relationship, the restraining force acts uniformly on the surface of the negative electrode layer 40. Thereby, during charging, metal ions can be precipitated uniformly on the surface of the negative electrode layer 40, and therefore the metal is less likely to accumulate on the end portions of the solid electrolyte layer 20 and the intermediate layer 30. The material for the restraining members 60 is not particularly limited, and any material for general solid-state batteries can be used. The restraining force of the restraining member 60 on the electrode laminate 1 may be e.g. within a range of 0.1 to 10 MPa.

Next, a method for manufacturing the solid-state secondary battery 100 according to the present embodiment will be explained below. The electrode laminate 1 can be prepared e.g. by a method including a positive electrode layer preparation step, a solid electrolyte layer formation step, an intermediate layer formation step, and a negative electrode layer formation step.

In the positive electrode layer preparation step, the positive electrode layer 10 is prepared. The positive electrode layer 10 can be prepared e.g. by forming the positive electrode active material layer 12 on the surface of the positive electrode current collector 11. The positive electrode active material layer 12 can be formed by using a method in which a positive electrode active material layer slurry is applied on the positive electrode active material layer 12 and then dried. As the positive electrode active material layer slurry, a dispersion liquid of the positive electrode active material containing a solvent, a positive electrode active material, and optionally a conductive assistant and a binder can be used. In the positive electrode layer preparation step, it is preferable that the insulating frame 15 is arranged so as to surround the outer periphery of the positive electrode active material layer 12.

In the solid electrolyte layer formation step, a solid electrolyte layer 20 is formed on the surface of the positive electrode active material layer 12 in the positive electrode layer 10. The solid electrolyte layer 20 can be formed by a method in which a solid electrolyte layer slurry is applied directly on the surface of the positive electrode active material layer 12, or a method in which a solid electrolyte layer slurry is applied on a surface of a separately-prepared support sheet and then dried to form the solid electrolyte layer 20, and the solid electrolyte layer 20 is transferred to the surface of the positive electrode active material layer 12 at a predetermined pressure. As the solid electrolyte layer slurry, e.g. a dispersion liquid of a solid electrolyte containing a solvent, a solid electrolyte, and optionally a binder can be used. The solid electrolyte layer 20 can be formed by a method in which the solid electrolyte layer is integrated with the substrate and self-supported, and then placed on the positive electrode layer. For example, a non-woven fabric or a woven fabric can be used as the substrate. A polyester resin such as PET can be used as the material for the substrate.

In the intermediate layer formation step, the intermediate layer 30 is formed on the surface of the solid electrolyte layer 20, opposed to the positive electrode active material layer 12 side. The intermediate layer 30 can be formed by a method in which an intermediate layer slurry is directly applied on the surface of the solid electrolyte layer 20 and then dried, or a method in which an intermediate layer slurry is applied on a surface of a separately-prepared support sheet and then dried to form the intermediate layer 30, the intermediate layer 30 is transferred to the surface of the solid electrolyte layer 20 at a predetermined pressure. A dispersion liquid of an intermediate layer forming material containing a solvent, metal nanoparticles, amorphous carbon, and optionally a binder can be used as the intermediate layer slurry.

In the negative electrode layer formation step, the negative electrode layer 40 is formed on the surface of the intermediate layer 30, opposed to the solid electrolyte layer 20 side. The negative electrode layer 40 can be formed by a method in which a previously-prepared negative electrode current collector 41 is placed on the surface of the intermediate layer 30.

The intermediate layer formation step and the negative electrode layer formation step may be simultaneously advanced in parallel. For example, the intermediate layer 30 and the negative electrode layer 40 may be previously integrated and self-supported to form an intermediate layer-negative electrode layer laminate, and the intermediate layer 30 of the laminate may be placed on the surface of the solid electrolyte layer 20. The intermediate layer-negative electrode layer laminate can be formed e.g. by applying and drying an intermediate layer slurry on the surface of the negative electrode current collector 41 to form the intermediate layer 30.

As described above, an electrode laminate 1 including the positive electrode layer 10, the solid electrolyte layer 20, the intermediate layer 30, and the negative electrode layer 40 laminated in this order can be obtained. In the obtained electrode laminate 1, the layers may be integrated by press as appropriate.

The solid-state secondary battery 100 can be prepared as follows. One end of the positive electrode tab is connected to the positive electrode current collector 11 of the obtained electrode laminate 1, and one end of the negative electrode tab is connected to the negative electrode current collector 41. Subsequently, the electrode laminate 1 is accommodated in the exterior body 50 such that the other ends of the positive and negative electrode tabs protrude outward, and the exterior body 50 is sealed. Then, the restraining members 60 are placed on the outer surface of the exterior body 50 to restrain the electrode laminate 1 by a predetermined restraining force.

In the solid-state secondary battery 100 according to the present embodiment configured as above, since the positive electrode-non-facing region 22 of the solid electrolyte layer 20 has a porosity as low as 5% or lower and is dense, metal ions released from the positive electrode layer 10 and the negative electrode layer 40 are less likely to move within the positive electrode-non-facing region during charging and discharging. Thus, metal ions are less likely to precipitate on the end portion of the solid electrolyte layer 20. Consequently, the solid-state secondary battery 100 according to the present embodiment has excellent cyclability.

In the solid-state secondary battery 100 according to the present embodiment, when a ratio [(D1−D2)/D1×100] of a difference between the apparent densities of the positive electrode-facing region 21 and the positive electrode-non-facing region 22 (D1−D2) to the apparent density D1 of the positive electrode-facing region 21 in the solid electrolyte layer 20 is in the range described above, the difference in the apparent density between the positive electrode-facing region 21 and the positive electrode-non-facing region 22 is small. Thus, metal ions released from the positive electrode layer 10 and the negative electrode layer 40 and fed to the positive electrode-facing region 21 are less likely to move toward the positive electrode-non-facing region 22 side, and the metal ions are less likely to precipitate on the end portion of the solid electrolyte layer 20.

In addition, in the solid secondary battery 100 of the present embodiment, when the adhesion strength in layers of the positive electrode-non-facing region 22 of the solid electrolyte layer 20 satisfies the above-described value, the shape stability of the positive electrode-non-facing region 22 is high. Therefore, the metal ions are less likely to deposit at the end portion of the solid electrolyte layer 20 over a long period of time.

In the solid secondary battery 100 of the present embodiment, when the ratio [(E1−E2)/E1×100] of the difference (E1−E2) between the composite modulus of elasticity of the positive electrode-facing region 21 and the composite modulus of elasticity of the positive electrode-non-facing region 22 to the composite elastic modulus E1 of the positive electrode-facing region 21 of the solid electrolyte layer 20 satisfies the above-described value, the difference in the composite moduli of elasticity between the positive electrode-facing region 21 and the positive electrode-non-facing region 22 is small. This reduces variations in the thicknesses of the positive electrode-facing region 21 and the positive electrode-non-facing region 22 when a restraining force is applied to the solid secondary battery 100. Therefore, even when a restraining force is applied to the solid-state secondary battery 100, the interface and the structure of each member in the solid-state secondary battery can be maintained, and local reaction and current concentration can be suppressed. Furthermore, in the solid-state secondary battery 100 according to the present embodiment, when the solid electrolyte layer 20 contains a sulfide solid electrolyte material, the dense positive electrode-non-facing region 22 with a low porosity can be easily formed.

In the solid-state secondary battery 100 according to the present embodiment, even if the intermediate layer 30 is provided between the solid electrolyte layer 20 and the negative electrode layer 40, metal ions are less likely to precipitate on the end portion of the intermediate layer 30 because the solid electrolyte layer 20 has the positive electrode-non-facing region 22. If the intermediate layer 30 has a porosity higher than that of the solid electrolyte layer 20, the cyclability can be further improved because uneven metal precipitation on the negative electrode layer 40 interface of the solid-state secondary battery 100 can be suppressed.

In the solid-state secondary battery 100 according to the present embodiment, the outer periphery of the positive electrode active material layer 12 is surrounded by the insulating frame 15, and the positive electrode-non-facing region 22 is supported by the insulating frame 15, and therefore the strength of the positive electrode-non-facing region 22 is improved. Even if the metal accumulates on the end portions of the solid electrolyte layer 20 and the intermediate layer 30, the metal is less likely to reach the positive electrode active material layer 12. Thus, the positive electrode layer 10 and the negative electrode layer 40 are less likely to cause a short circuit, and the cyclability is further improved.

Although the embodiment of the present invention has been described above, the invention is not limited to the above embodiment. For example, in the solid-state secondary battery 100 according to the present embodiment, the outer periphery of the positive electrode active material layer 12 is surrounded by the insulating frame 15, but the insulating frame 15 may be omitted. In this case, it is preferable that the outer periphery of the negative electrode layer 40 is covered with the insulating frame, and the positive electrode-non-facing region 22 of the solid electrolyte layer 20 is supported by the insulating frame.

In the solid-state secondary battery 100 according to the present embodiment, although the metal precipitate layer 42 is used as the negative electrode active material layer, the negative electrode active material layer is not limited to the metal precipitate layer 42. The negative electrode active material layer may also be a layer containing a negative electrode active material capable of occluding and releasing the charge transfer media such as lithium ions. In this case, the negative electrode active material layer may be placed on the surface of the current collecting substrate 41a. As the negative electrode active material, any material for negative electrodes of general solid secondary batteries can be used. When the charge transfer media are lithium ions, examples of the negative electrode active material include a lithium transition metal oxide such as lithium titanate, a transition metal oxide such as TiO₂, Nb₂O₃, and WO₃, Si, SiO, a metal sulfide, a metal nitride, and a carbon material such as artificial black lead, natural black lead, graphite, soft carbon, and hard carbon. The negative electrode active material layer may optionally contain a solid electrolyte from the viewpoint of improving the charge transfer medium conductivity. The negative electrode active material layer may optionally contain a conductive assistant to improve the electric conductivity. Furthermore, the negative electrode active material layer may optionally contain a binder from the viewpoint of expressing flexibility, and the like. As the solid electrolyte, the conductive assistant, and the binder, those for general solid-state batteries can be used.

### EXAMPLES

The present invention will be explained below in detail with reference to Examples. However, the present invention is not limited to Examples.

### Example 1

### [Preparation of Positive Electrode Layer]

A rectangular aluminum foil having an X-directional length of 30.0 mm, a Y-directional length of 30.0 mm, and a thickness of 15.0 μm was prepared as a positive electrode current collector. A mixture of 80 parts by mass of lithium-nickel-cobalt-manganese composite oxide (NCM622) as the positive electrode active material, 17 parts by mass of argyrodite type sulfide solid electrolyte as the solid electrolyte, 2 parts by mass of carbon black as the conductive assistant, and 1 part by mass of styrene-butadiene rubber (SBR) type binder as the binder was prepared. The resulting mixture was dispersed in 43 parts by mass of butyl butyrate to prepare the positive electrode active material layer slurry. The resulting positive electrode active material layer slurry was applied on the center of the positive electrode current collector using a bar coater such that the applied layer had an X-directional length of 20.0 mm, a Y-directional length of 20.0 mm, and a post-drying basis weight of 27 mg/cm², and then dried to form a positive electrode active material layer. In this way, the electrode active material layer was prepared.

### [Placement of Insulating Frame]

An insulating sheet having an X-directional length of 30.0 mm, a Y-directional length of 30.0 mm, and a thickness of 80.0 μm was prepared. An opening having an X-directional length of 20.0 mm and a Y-directional length of 20.0 mm was formed in the center of the insulating sheet to prepare an insulating frame. The resulting insulating frame was placed around the positive electrode active material layer.

### [Preparation of Solid Electrolyte Layer]

A dispersion liquid of an argyrodite type sulfide solid electrolyte (median diameter: 3.0 μm) was applied on a support sheet and then dried to form an argyrodite type sulfide solid electrolyte layer having an X-directional length of 27.0 mm, a Y-directional length of 27.0 mm, and a post-drying basis weight of 20 mg/cm². The argyrodite type sulfide layer formed on the support sheet was transferred to the center of the positive electrode active material layer to prepare a solid electrolyte layer.

### [Preparation of Intermediate Layer]

A mixture of: a total of 95 parts by mass of Sn particles (median diameter: 0.07 μm) as metal nanoparticles and acetylene black (median diameter: 0.05 μm) as amorphous carbon; and 5 parts by mass of PVDF binder as a binder was prepared. The resulting mixture was dispersed in 1000 parts by mass of N-methyl-2-pyrrolidone (NMP) to prepare an intermediate layer slurry. The resulting intermediate layer slurry was applied on the center of the solid electrolyte layer using a gravure coater such that the applied layer had an X-directional length of 22.0 mm, a Y-directional length of 22.0 mm, and a post-drying basis weight of 0.4 mg/cm², and then dried to prepare an intermediate layer. In this way, a positive electrode layer-solid electrolyte layer-intermediate layer laminate including the positive electrode layer, the solid electrolyte layer, and the intermediate layer laminated in this order was obtained.

### [Preparation of Negative Electrode Current Collector]

A laminated metal foil (total thickness: 50 μm) including a 10 μm-thick copper foil and a 40 μm-thick lithium foil was prepared. The laminated metal foil was cut out into a piece having an X-directional length of 21.0 mm and a Y-directional length of 21.0 mm to prepare a negative electrode current collector.

### [Preparation of Electrode Laminate]

The positive electrode layer-solid electrolyte layer-intermediate layer laminate obtained above was densified by isostatic pressing. The pressing was performed under a condition that a heating temperature was 120° C., a pressure was 980 Mpa, and a retention time was 5 minutes. Next, the negative electrode current collector obtained above was arranged such that the lithium foil was in contact with the surface of the intermediate layer of the positive electrode layer-solid electrolyte layer-intermediate layer laminate, and then pressed to prepare an electrode laminate including the positive electrode layer, the solid electrolyte layer, the intermediate layer, and the negative electrode current collector laminated in this order. After the densification pressing, the positive electrode layer had a thickness of 78 μm, the solid electrolyte layer had a thickness of 100 μm, and the intermediate layer had a thickness of 3 μm.

### [Preparation of Solid-State Secondary Battery]

Tabs were attached to each of the positive and negative electrode current collectors of the electrode laminate obtained as described above, then the electrode laminate was put into a bag-shaped laminate pack. Subsequently, the laminate pack was sealed under argon atmosphere.

Restraining members having an X-directional length of 21.0 mm and a Y-directional length of 21.0 mm were prepared. The restraining members were placed so as to face the negative electrode current collector of the electrode laminate from the surface of the laminate pack, and a restraining force of 3 MPa was applied to the electrode laminate to prepare a solid-state secondary battery.

### Examples 2 to 3 and Comparative Examples 1 to 3

A solid-state secondary battery was prepared in the same manner as in Example 1, except that the conditions (method, heating temperature, and pressure) for densification treatment of the positive electrode layer-solid electrolyte layer-intermediate layer laminate were changed to those in Table 1 below in the preparation of the electrode laminate.

TABLE 1

Conditions for electrode laminate densification

| | | Heating | |
|---|---|---|---|
| | | temperature | Pressure |
| | Densification method | (° C.) | (MPa) |
| Example 1 | Isostatic pressing | 120 | 980 |
| Example 2 | Isostatic pressing | 25 | 980 |
| Example 3 | Isostatic pressing | 100 | 980 |
| Comparative | Roll pressing | 25 | 900 |
| Example 1 | | | |
| Comparative | Isostatic pressing | 25 | 600 |
| Example 2 | | | |
| Comparative | Roll pressing | 25 | 950 |
| Example 3 | | | |

### Physical Properties of Solid Electrolyte Layer

The solid electrolyte layer was taken out from the electrode laminate prepared in Examples 1 to 3 and Comparative Examples 1 to 3. The obtained solid electrolyte layer was separated into a positive electrode-facing region and a positive electrode-non-facing region. The weights and the sizes of the positive electrode-facing region and the positive electrode-non-facing region were measured to determine their apparent densities. From the determined apparent density (D1) of the positive electrode-facing region and the apparent density (D2) of the positive electrode-non-facing region, a solution of the equation: (D1−D2)/D1×100 was calculated. A volume resistivity (20° C.) and a true density were measured for the positive electrode-non-facing region. From the determined true density and apparent density, a filling rate was determined to calculate a porosity of the positive electrode-non-facing region. The adhesion strength in layers of the positive electrode-non-facing region was measured, using a surface and interface cutting analysis system (SAICAS). Additionally, the composite moduli of elasticity of the positive electrode-facing region and the electrode-non-facing region were measured and (E1−E2)/E2×100 was calculated from the obtained composite modulus of elasticity (E1) of the electrode-facing region and the obtained composite modulus of elasticity (E2) of the electrode-non-facing region. The results are presented in Table 2.

### Physical Properties of Intermediate Layer

The intermediate layers were taken out from the electrode laminates prepared in Examples 1 to 3 and Comparative Examples 1 to 3. The weights and the sizes of the obtained intermediate layers were measured to determine their apparent densities. True densities of the intermediate layers were also measured. From the determined true densities and apparent densities, filling rates were determined to calculate porosities of the intermediate layers. The results are presented in Table 3.

### Battery Property

The solid-state secondary battery prepared in Examples 1 to 3 and Comparative Examples 1 to 3 was subjected to a cycle test in which charge and discharge were repeated at an upper limit charge voltage of 4.3 V, a lower limit discharge voltage of 2.65 V, and a C rate of ⅓ C. A ratio of a discharge capacity to a charge capacity (discharge capacity/charge capacity×100) at a first cycle was defined as an initial charge-discharge efficiency. If a ratio of the discharge capacity at the second cycle to the charge capacity at the first cycle (second charge capacity/first discharge capacity×100) was higher than 105%, a short-circuit behavior during the second charge was evaluated as “Yes”, and if a ratio of the discharge capacity at the second cycle to the charge capacity at the first cycle was 105% or lower, the short-circuit behavior during the second charge was evaluated as “No”. The results are presented in Table 3.

TABLE 2

| | Physical property of solid electrolyte layer | | | | |
|---|---|---|---|---|---|
| | | | | | Composite |
| | Positive electrode- | | | | modulus of |
| | non-facing region | | | Density | elasticity |
| | Volume | | Adhe- | (D1 − | (E − |
| | resis- | Poros- | sion | D2)/D1 × | E2)/E1 × |
| | tivity | ity | strength | 100 | 100 |
| | (Ω · cm) | (%) | in layers | (%) | (%) |
| Example 1 | 1 × 10⁷ | 3.0 | 1.2 | 0.6 | 2.1 |
| Example 2 | 1 × 10⁷ | 4.5 | 0.9 | 1.1 | 4.4 |
| Example 3 | 1 × 10⁷ | 4.0 | 1.0 | 1.5 | 3.9 |
| Comparative | 1 × 10⁷ | 10.0 | 0.2 | 3.6 | 22.3 |
| Example 1 | | | | | |
| Comparative | 1 × 10⁷ | 8.0 | 0.2 | 2.2 | 15.6 |
| Example 2 | | | | | |
| Comparative | 1 × 10⁷ | 5.5 | 0.3 | 4.0 | 24.6 |
| Example 3 | | | | | |

TABLE 3

| | Physical | Battery property | |
|---|---|---|---|
| | properties | | Presence of |
| | of interme- | Initial charge/ | short-circuit |
| | diated layer | discharge | behavior during |
| | Porosity(%) | efficiency(%) | the second charge |
| Example 1 | 41 | 89.7 | No |
| Example 2 | 43 | 89.8 | No |
| Example 3 | 42 | 89.9 | No |
| Comparative | 43 | 66.4 | Yes |
| Example 1 | | | |
| Comparative | 45 | 71.5 | Yes |
| Example 2 | | | |
| Comparative | 43 | 77.8 | Yes |
| Example 3 | | | |

From the results presented in Tables 2 and 3, it was confirmed that the solid secondary batteries obtained in Examples 1 to 3 with the solid electrolyte layer having the positive electrode-non-facing region with the porosity of lower than 5% had a high initial charge-discharge efficiency and were less likely to cause a short circuit. In contrast, the solid secondary batteries obtained in Comparative Examples 1 to 3 with the positive electrode-non-facing region having the porosity of 5% or higher had a low initial charge-discharge efficiency and caused a short circuit during the second charge. This is because lithium precipitated in the voids within the positive electrode-non-facing region during charging in the solid secondary batteries of Comparative Examples 1 to 3.

### EXPLANATION OF REFERENCE NUMERALS

1 Electrode laminate
10 Positive electrode layer
11 Positive electrode current collector
12 Positive electrode active material layer
15 Insulating frame
20 Solid electrode layer
21 Positive electrode-facing region
22 Positive electrode-non-facing region
30 Intermediate layer
40 Negative electrode layer
41 Negative electrode current collector
41a Current collecting substrate
41b Metal layer
42 Metal precipitate layer
50 Exterior body
60 Restraining member
100 Solid-state secondary battery

What is claimed is:

1. A solid-state secondary battery comprising an electrode laminate, and an exterior body housing the electrode laminate,
the electrode laminate having a positive electrode layer, a negative electrode layer, and a solid electrolyte layer placed between the positive electrode layer and the negative electrode layer,
the positive electrode layer comprising a positive electrode current collector and a positive electrode active material layer,
the solid electrolyte layer having a positive electrode-facing region that faces the positive electrode active material layer, and a positive electrode-non-facing region that does not face the positive electrode layer, and
the positive electrode-non-facing region having a porosity of lower than 5%.

2. The solid-state secondary battery according to claim 1, wherein an equation: −3%≤(D1−D2)/D1×100≤+3% is satisfied under a condition that an apparent density of the positive electrode-facing region is defined as D1 and an apparent density of the positive electrode-non-facing region is defined as D2.

3. The solid-state secondary battery according to claim 1, wherein an adhesion strength within layers of the positive electrode-non-facing region of the solid-electrolyte layer is greater than 0.3 kN/m.

4. The solid-state secondary battery according to claim 1, wherein an equation: (E1−E2)/E1×100≤15% is satisfied under a condition that a composite modulus of elasticity of the positive electrode-facing region of the solid-electrolyte layer is defined as El and a composite modulus of elasticity of the positive electrode-non-facing region is defined as E2.

5. The solid-state secondary battery according to claim 1, wherein the solid electrolyte layer contains a sulfide solid electrolyte material.

6. The solid-state secondary battery according to claim 1, wherein an intermediate layer is provided between the negative electrode layer and the solid electrolyte layer, and
the intermediate layer has a porosity higher than that of the solid electrolyte layer.

7. The solid-state secondary battery according to claim 6, wherein the intermediate layer has a thickness of 5 μm or less in a lamination direction of the electrode laminate.

8. The solid-state secondary battery according to claim 6, wherein the intermediate layer contains metal nanoparticles and amorphous carbon.

9. The solid-state secondary battery according to claim 1, wherein an outer periphery of the positive electrode active material layer is surrounded by an insulating frame.
